(19) United States
(12) Patent Application Publication
(10) Pub. No.: US 2025/0019311 A1
(43) Pub. Date: Jan. 16, 2025

(54) BORON NITRIDE NANOTUBE INTERMEDIARIES FOR NANOMATERIALS

(71) Applicant: BNNT, LLC, Newport News, VA (US)

(72) Inventors: Mohammad H. KIRMANI, Newport News, VA (US); Thomas G. DUSHATINSKI, Newport News, VA (US); Clay F. HUFF, Newport News, VA (US); Kevin C. JORDAN, Newport News, VA (US); Eric R. KENNEDY, Newport News, VA (US); Lyndsey R. SCAMMELL, Newport News, VA (US); Michael W. SMITH, Newport News, VA (US); Jonathan C. STEVENS, Newport News, VA (US); R. Roy WHITNEY, Newport News, VA (US)

(21) Appl. No.: 18/705,399

(22) PCT Filed: Oct. 28, 2022
(86) PCT No.: PCT/US2022/048220

§ 371 Date: Apr. 26, 2024

Related U.S. Application Data
(60) Provisional application No. 63/273,459, filed on Oct. 29, 2021.

(51) Int. Cl. C04B 35/583; C04B 35/622

(52) U.S. Cl. CPC C04B 35/583; C04B 35/6229; C04B 2235/386; C04B 2235/5284

(57) ABSTRACT

The processes and products described herein optimize transformation of BNNT as-synthesized material into BNNT intermediary materials. Process steps include refining to remove boron particulates, high temperature refining to break bonds between BNNT, h-BN nanocages, h-BN nanosheets and amorphous BN particles, centrifuging and microfluidic separation, and electrophoresis. Resultant BNNT intermediary materials include purified BNNT in solution, BNNT gels, h-BN nanocages, and h-BN nanosheets, gel spun BNNT fibers, hydrophilic defect enhanced BNNT materials, BNNT patterned sheets, and BNNT strands. Applications that will utilize these BNNT precursor feedstock materials include making BNNT based aligned components, thin films, aerogels, thermal conductivity enhancements, structural materials, ceramic, metal, and polymer composites, and removal of PFAS pollutants from water.

### STATEMENT REGARDING GOVERNMENT SUPPORT

None.

### FIELD OF THE INVENTION

The present disclosure relates to boron nitride nanotube (BNNT) intermediaries for various nanomaterials.

### BACKGROUND—INTRODUCTION

BNNTs may be used as a feedstock material for a wide variety of nanomaterials, such as, for example, BNNT liquid crystals, neat BNNT fibers, gel spun BNNT fibers, electrospun BNNT fibers, patterned BNNT sheets, and BNNT composites with aligned fibers, among other nanomaterials. The formation of these nanomaterials call for high quality, purified precursor (HQPP) feedstock BNNTs, i.e., a few-wall (e.g. 1-10 walls, and mostly 2-3 walls) BNNT precursor feedstock material that is predominantly BNNT, with a minimal amount of boron particulates, amorphous boron nitride (a-BN), h-BN nanocages, h-BN nanosheets, and any other non-BNNT materials. Previous attempts to manufacture HQPP BNNTs have suffered from low yield and inadequate quality; their yields from the as-synthesized BNNT material typically have been very low, i.e. below 10 wt. % of the as-synthesized material. An additional disadvantage of prior attempts to manufacture HQPP BNNTs is that the average BNNT lengths as determined by SEM imaging are below 3 microns, and often significantly less, likely due to the processes utilized. In order to be commercially feasible and useful for nanomaterial synthesis, HQPP feedstock BNNTs need to be manufactured at sufficient yields, and with higher average BNNT lengths.

The h-BN nanocages and h-BN nanosheets form two additional categories of BNNT-related precursor materials that have value for applications, particularly those in which BNNT alignment is not important. For example, h-BN nanocages have been observed to have a high density of sub-bandgap sites that are potentially important for quantum devices, a property independent of BNNT alignment.

Typical BNNT synthesis processes result in an as-synthesized BNNT material with less than half of its mass being BNNTs, and over half of its mass being various forms of boron particles, a-BN, h-BN nanosheets, and h-BN nanocages. The h-BN nanocages may encapsulate boron particles. Further, the BNNTs are usually joined together at nodes where several BNNTs come together, frequently in combination with a-BN, h-BN nanocages, and h-BN nanosheets. These nodes hinder or prevent the smooth joining together of the BNNTs to form aligned components or precursor feedstock BNNT materials with preferred purity. Additionally, there are some forms of BNNTs that, while having less boron particulates, a-BN, h-BN nanosheets, and h-BN nanocages, have more than ten walls, tubes that are not highly crystalline, outer walls with rough surfaces, and/or the inflexible tubes. These properties limit the usefulness of such BNNTs in subsequent nanomaterial synthesis. Consequently, these forms of BNNTs are not preferred for many applications. What is needed then, are forms and processes making precursor feedstock BNNT materials suitable for use in a broad range of applications including making BNNT based aligned components, thin films, gels, aerogels, thermal conductivity enhancements, structural materials, and ceramic, metal, and polymer composites.

### BRIEF SUMMARY

Described herein are BNNT intermediary materials, HQPP BNNT precursor feedstock materials having sufficient quality, purity, and properties for serving as feedstock to produce various nanomaterials, and processes for manufacturing BNNT intermediary materials. The processes and products described herein optimize the transformation of as-synthesized BNNT material into BNNT precursor feedstock materials, and in particular HQPP BNNT precursor feedstock materials. The as-synthesized BNNT material includes, but is not limited to, BNNTs manufactured using a high-temperature, high-pressure synthesis process. Process steps include (i) refining to remove boron particulates; (ii) high temperature refining to remove a-BN, break bonds between BNNT, h-BN nanocages, h-BN nanosheets, and amorphous BN particles; (iii) centrifuging and microfluidic separation; and (iv) electrophoresis.

Embodiments of the present approach may take the form of one or more methods for producing a BNNT intermediary material. In some embodiments, the method for producing a BNNT intermediary material from an as-synthesized BNNT material includes:
removing boron particulates from the as-synthesized BNNT material;
breaking covalent bonds between BNNTs and h-BN nanocages and h-BN nanosheets in the as-synthesized BNNT material;
dissolving the BNNTs, h-BN nanocages, and h-BN nanosheets in a solvent; and
separating BNNTs from h-BN nanocages and h-BN nanosheets to produce a BNNT intermediary material.

Some embodiments may include separating agglomerations in the BNNTs. Separating BNNTs from h-BN nanocages and h-BN nanosheets may be performed through, as an example, electrophoresis. In some embodiments, the BNNT intermediary material may be collected on an anode.

Embodiments of the present approach may be further processed to form one or more BNNT intermediary materials, such as a BNNT mat, BNNT powder, or a BNNT gel. For example, a BNNT gel may be formed through forming an electric field in a solution containing the BNNT intermediary material. Those materials may, in turn, be further processed into another form, such as a BNNT fiber, BNNT strands, and a patterned BNNT sheet.

Some embodiments may further include plasma treating the BNNT intermediary material to introduce surface defects on the BNNTs in the BNNT intermediary material.

In some embodiments, boron particulates are removed by wet thermal processing in a nitrogen gas environment. Wet thermal processing may include processing the as-synthesized BNNT material at a temperature between 500-650° C. in a water-vapor and nitrogen environment. In some embodiments, breaking covalent bonds involves processing the BNNTs at a temperature between 750-925° C. for about 5-180 minutes. In some embodiments, breaking covalent bonds involves processing in an inert gas at temperature between 1900-2300° C. for about 5-30 minutes.

In a demonstrative embodiment, a boron nitride nanotube (BNNT) intermediary material may be produced from an as-synthesized BNNT material by:
processing the as-synthesized BNNT material at a temperature between 500-650° C. in a water-vapor and nitrogen gas environment to remove boron particulates from the as-synthesized BNNT material and form a first processed BNNT material;
processing the first processed BNNT material at a temperature between 750-925° C. to break covalent bonds between BNNTs and h-BN nanocages and h-BN nanosheets and form a second processed BNNT material having BNNTs, h-BN nanocages, and h-BN nanosheets;
separating, by electrophoresis, BNNTs from h-BN nanocages and h-BN nanosheets; and collecting the separated BNNTs as a BNNT intermediary material.

In another demonstrative embodiment, a BNNT intermediary material may be produced from an as-synthesized BNNT material by:
removing boron particulates from the as-synthesized BNNT material and form a first processed BNNT material having BNNTs, h-BN nanocages, and h-BN nanosheets;
breaking covalent bonds between the BNNTs, h-BN nanocages, and h-BN nanosheets in the first processed BNNT material;
separating and collecting the BNNTs as a BNNT intermediary material.

The methods disclosed herein may be used to prepare a variety of BNNT intermediary materials from an as-synthesized BNNT material. The BNNT intermediary material may take the form of one or more of:
a solution of deagglomerated BNNT, BN nanocages and BN nanosheets;
a composition of BNNTs, h-BN nanocages, and h-BN nanosheets, in which covalent bonds between the species have been broken;
h-BN nanocages and h-BN nanosheets collected on an electrophoresis anode;
a solution of BNNT nanotubes separated from h-BN nanocages and h-BN nanosheets via electrophoresis;
BNNT gel collected on an electrophoresis anode;
BNNT fibers spun from a BNNT gel;
BNNT* materials formed from plasma treatment;
BNNT patterned sheets collected via electrophoresis; and
BNNT strands collected via electrophoresis.

In one demonstrative embodiment, the BNNT intermediary material is a composition of BNNTs having: 1) few walls, i.e. 70% of the BNNTs have 3 or fewer walls; 2) small diameters, i.e. 70% of the BNNTs have diameters below 8 nm; 3) 80% of the BNNTs have length:diameter aspect ratios greater than 100:1; 4) 70% of the BNNTs have lengths greater than 1 micron; 5) less than 1 wt. % of the mass as particulate boron; 6) less than 5 wt. % and preferably less than 1 wt. % of the mass as a-BN; 7) less than 5 wt. % and preferably less than 2 wt. % of the mass as h-BN nanosheets; 8) less than 5% and preferably less than 1% of the mass as h-BN nanocages; 9) less than 2 wt. % and preferably less than 1 wt. % of the mass as any form of boron, boron oxide, boron-nitrogen-hydrogen compounds, or any other non BN compound; and 10) the surface area BET greater than 300 m²/g.

In another demonstrative embodiment, the BNNT intermediary material is a composition having greater than 90 wt. % BN nanocages and BN nanosheets. In another demonstrative embodiment, the BNNT intermediary material is a hydrophilic BNNT intermediary material having surface defects having a surface area in excess of 300 m²/g.

The disclosed processes can be used to manufacture the following types of BNNT precursor and intermediary materials: purified BNNT in solution, BNNT gels, h-BN nanocages, and h-BN nanosheets, BNNT materials with enhanced defect (BNNT*), BNNT gel spun fibers, BNNT patterned sheets, and BNNT strands. It should be appreciated that numerous nanomaterials and applications can advantageously utilize one or more BNNT intermediary materials. Demonstrative applications and nanomaterials include BNNT-based aligned components, thin films, aerogels, thermal conductivity enhancements, structural materials, and ceramic, metal, and polymer composites.

### BRIEF DESCRIPTION OF THE DRAWINGS

FIG. 1 illustrates an embodiment of a process for making BNNT intermediary materials.

FIG. 2 shows an image of a refined BNNT puffball, after over 98 wt. % boron particulate removal.

FIG. 3 illustrates an embodiment of a refining and wet purification system.

FIG. 4 shows a distribution of HQPP BNNT diameters in an embodiment of the present approach.

FIG. 5 shows an image of electrophoresis electrodes and BNNT collection on anode.

FIG. 6 shows an SEM of h-BN nanocages and h-BN nanosheets collected from an anode in an embodiment of the present approach.

FIG. 7 shows an SEM of BNNT in solution after electrophoresis, according to an embodiment of the present approach.

FIG. 8 shows a sample BNNT gel produced in an embodiment of an electrophoresis process according to the present approach.

FIG. 9 shows BNNT gel spun fibers produced according to an embodiment of the present approach.

FIG. 10 shows an apparatus for converting a BNNT mat into BNNT* in an argon plasma.

FIGS. 11A and 11B illustrate an example of a patterned collection of BNNT material.

FIG. 12 shows BNNT strands in an electrophoresis system according to an embodiment of the present approach.

FIG. 13 is an image of a 3-wall BNNT have a 4.5 nm diameter.

### DETAILED DESCRIPTION

This disclosure describes various BNNT intermediary materials, including HQPP BNNT precursor materials, and processes for manufacturing the same. It should be appreciated that the following embodiments and examples are demonstrative of the present approach, and are not intended to limit the scope of the present approach.

There are a number of desirable properties for HQPP feedstock BNNT materials used for liquid crystals, neat BNNT fibers, gel spun BNNT fibers, electrospun BNNT fibers, and BNNT composites with aligned fibers of commercial interest. These properties include: 1) high crystallinity, i.e., less than one crystal defect per one hundred diameters of length; 2) few walls, i.e. 70% of the BNNTs have 3 or fewer walls; 3) small diameters, i.e. 70% of the BNNTs have diameters below 8 nm; 4) 80% of the BNNTs have length:diameter aspect ratios greater than 100:1; 5) 70% of the BNNTs have lengths greater than 2 microns; 6) less than 1 wt. % of the mass as particulate boron; 7) less than 5 wt. %, and preferably less than 1 wt. %, of the mass as a-BN; 8) less than 5 wt. %, and preferably less than 1 wt. %, of the mass as h-BN nanosheets; 9) less than 5%, and preferably less than 1%, of the mass as h-BN nanocages; 10) less than 2 wt. %, and preferably less than 1 wt. %, of the mass as any form of boron oxide, boron-nitrogen-hydrogen compounds, or any other non BN compound; and 11) the surface area BET of the BNNT precursor feedstock material is greater than 300 m²/g.

For measuring these parameters,
transmission electron microscopy (TEM) may be used to evaluate wall number and tube diameter by counting the number of walls in the BNNTs in a randomly collected selection of samples;
scanning electron microscopy (SEM) may be used to evaluate the relative percent impurities, including h-BN as nanosheets, nanocages, a-BN, c-BN, and boron particulates by counting the impurities in a randomly collected selection of samples; and
a combination of analysis of 10 representative HR-SEM micrographs at 20,000× magnification plus 20 representative TEM micrographs at 0.2 nm resolution of a refined BNNT material can be used to determine the relative fraction of BNNTs versus other h-BN nano-allotropes in the refined BNNT material.

While a BNNT precursor feedstock material that does not satisfy each of these parameters may—to a limited degree—be used to form liquid crystals, neat BNNT fibers, gel spun BNNT fibers, electrospun BNNT fibers, or BNNT composites with aligned fibers, the levels of alignment of the BNNTs and the strengths of their interfacing will be insufficient to produce a nanomaterial with preferred material properties. For example, depending on the unmet parameter(s), tensile strength and thermal conductivity may be unsuitable for the desired application, or applications relying on optimal purity will not reach their full performance potentials. For example, successfully forming BNNT liquid crystals and subsequently processing the liquid crystals into BNNT fibers of preferred strength (above 500 MPa tensile strength) and thermal conductivity (above 300 W/m·K) requires that the individual BNNT tubes can make close contact with each other over more than 50% of their length and preferably close contact over 80% of their length.

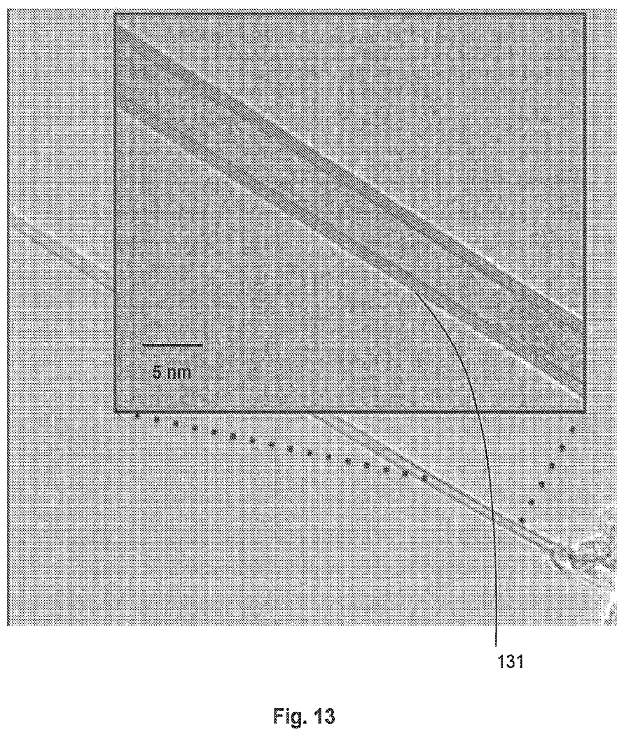

Embodiments of the present approach may use various types of BNNTs, although embodiments using high quality BNNT material will generate the preferred yields of HQPP BNNT. BNNT, LLC (Newport News, Virginia) produces high quality BNNT material by high temperature, high-pressure (HTP) methods that may be used in embodiments of the present approach. The synthesis processes are catalyst-free, and the processes only use boron and nitrogen gas as feedstock. The BNNTs in HQPP BNNT material from BNNT, LLC have few defects, 1- to 10-walls with the peak in the distribution at 2-3-walls and rapidly decreasing with larger number of walls. FIG. 13 illustrates a TEM image of a BNNT 131 having 3 walls and a 4.5 nm diameter. Typically, there are less than 10 wt. % of the BNNTs with 1-wall. BNNT diameters in these materials typically range from 1.5 to 6 nm, and they may extend beyond this range. Nanotube lengths in these materials typically range from a few hundreds of nm to hundreds of microns, and they may extend beyond this range.

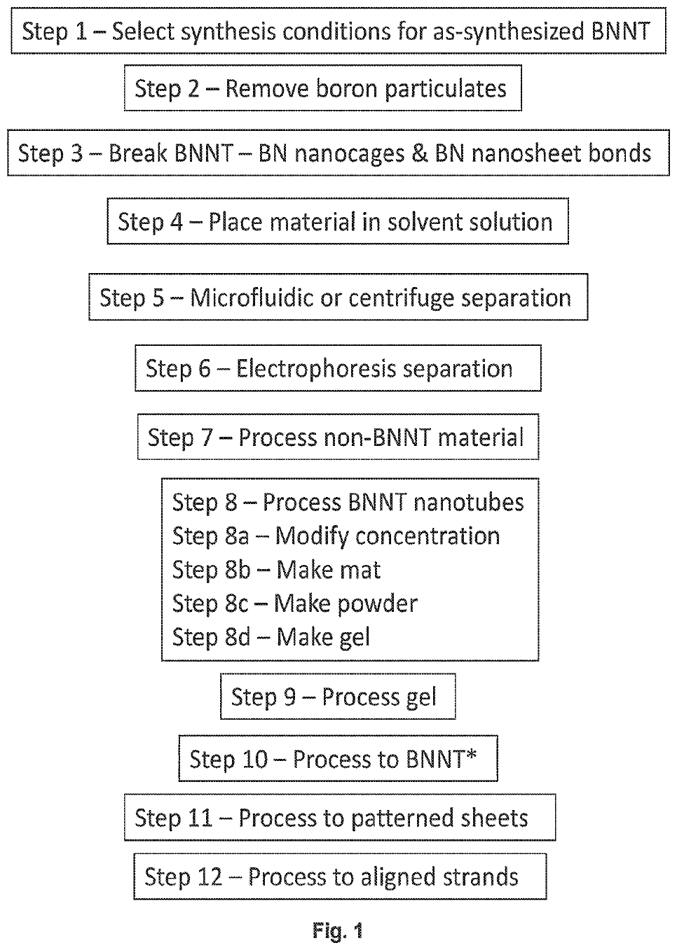

FIG. 1 illustrates a process for making BNNT intermediary materials, including HQPP BNNT material, according to embodiments of the present approach. At Step 1, the synthesis conditions for the particular as-synthesized BNNT material are selected. In other words, the process for producing a BNNT intermediary material is dependent upon the characteristics of the particular as-synthesized BNNT material. This description refers “as-synthesized BNNT material,” which refers to the BNNT material synthesized using methods available in the art. It should be appreciated that there are a wide range of potential as-synthesized BNNT materials, and the type and content of impurities (e.g., h-BN nanosheets, h-BN nanocages, a-BN, c-BN, and boron particulates), as well as the quality of the BNNTs (e.g., average length, number of walls, etc.) may vary considerably depending on the particular as-synthesized BNNT materials. Under the present approach, as-synthesized BNNT material may have been synthesized according to known methods, and, depending on the synthesis method and conditions, the as-synthesized BNNT material may be low quality or high quality. High quality BNNTs may be preferred for at least some embodiments of the present approach. U.S. Pat. Nos. 9,745,192, 9,776,865, 10,167,195, and International Patent Application PCT/US16/23432, filed Nov. 21, 2017, describe examples of synthesis apparatus and processes for high-quality as-synthesized BNNTs, and each is incorporated by reference in its entirety. It should be appreciated that the synthesis procedures occur in a nitrogen environment, under elevated pressures. The overall production of BNNT, compared to h-BN nanocages and h-BN nanosheets, is typically observed for nitrogen pressures in the range of 50-80 psi. Operating the synthesis at pressures in the range of 30-50 psi produces more, and typically slightly larger, h-BN nanocages, but fewer h-BN nanosheets while also producing more boron particulates. Operating the synthesis at pressures above 80 psi produces more h-BN nanosheets, with fewer smaller h-BN nanocages, and the BNNTs produced are typically shorter. These variations are observed for HTP synthesis for both laser and direct induction sources of energy feeding the boron melts in the synthesis process. The choice of synthesis conditions is the first step in optimizing the BNNT intermediary material for the specific application area of interest.

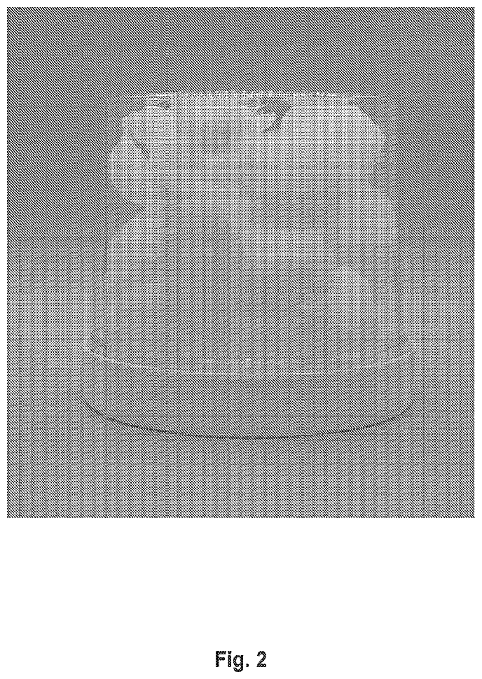

At Step 2, boron particulates are removed. Boron particulates and non-BNNT BN allotrope components may be removed (i.e., significantly reduced, as there may be residual particles after removal processing) through post-synthesis refinement processes described below in detail, such as those described below and in International Application No. PCT/US2017/063729, filed Nov. 29, 2017 and incorporated by reference in its entirety. These processes for removal of the boron particulates via a wet thermal process in a nitrogen gas environment, cause minimal or no damage to the BNNT in the as-synthesized BNNT material. An image of refined BNNT puffballs, after removal of boron particulates, is shown in FIG. 2. When the boron particulate removal processes occur at elevated temperatures and times of between about 650-900° C. and about 0.5-24 hours required to remove the a-BN, h-BN nanocages, and h-BN nanosheets, the yields of HQPP BNNTs present typically drop to below 10 wt. % of the as-synthesized material; shorter times correlate with the higher end of the temperature range and longer times correlate with the lower end of the temperature range. In some embodiments, acids such as nitric acid, and bases such as ammonia, and a variety of temperatures and times have also been utilized to remove boron particulates, but resulted in low yields of HQPP BNNTs. Further, the acids and bases also remove BNNTs or damage the BNNTs, introducing undesirable defects. Additionally, the h-BN nanocages and h-BN nanosheets are also a valuable material for some applications, such as applications calling for nanoscale BN particulates, and in particular sub-200 nm and sub-100 nm sized particulates, or applications calling for BN nanoparticles with a significant density of surface defects, such as 1 to 100 crystal defects per length scale of the BN nanoparticle. By adjusting the synthesis conditions, and in particular the nitrogen pressure and the laser power levels, the process can selectively provide BNNT material with BN nanoparticles, with the BN nanoparticles being a majority of h-BN nanocages or a majority of h-BN nanosheets.

Additional processes for synthesizing high quality BNNTs, including high crystallinity and having few walls, include laser heating of boron melts and RF heating of boron melts, boron particles, and/or BN particles. Pressure ranges for most of these processes range from 1 atm to 250 atm, and some processes include hydrogen gas in addition to nitrogen gas. As those of ordinary skill in the art will appreciate, the synthesis processes include variables that may be adjusted to adjust the synthesized product. For example, in synthesis processes that produce BNNT material from a boron melt, reduction in boron melt size during processing may require adjustment to the laser or RF power levels to produce a consistent product. Preferably, the process is operated to produce material that can successfully be further refined to use in nanomaterials that require HQPP BNNT material, h-BN nanocage precursor feedstock material, and/or h-BN nanosheet precursor feedstock material.

As a demonstrative example, if the nitrogen pressure in the synthesis chamber is at 20 psi, and no hydrogen is present, then a significant fraction (often greater than 10 wt. %) of the as-synthesized BNNT material will be h-BN nanocages that cannot be easily removed or separated in Step 2. Consequently, it is common for embodiments of these synthesis processes are operated in the 3 atm to 20 atm range, to avoid excessive h-BN species.

One challenge in removing boron particulates (and in some embodiments, a-BN and h-BN nanosheets and h-BN nanocages), and in addition weaken the connections between the BNNTs at nodes, is to avoid introducing defects on the BNNTs via the removal process. Acids, such as nitric acid, and bases, such as ammonia, are sometimes used for refining and purifying as-synthesized BNNT materials, but these acids and bases have the potential to damage or destroy the BNNTs, thereby introducing undesirable defects. Controlling the time, temperature, pressure, and level of acidity can mitigate these effects.

A preferred alternative to utilizing acids or bases for Step 2 is to use high temperature water vapor in the form of superheated steam in a nitrogen environment or a nitrogen environment that has some oxygen present. In preferred embodiments, the wet thermal process can run at ambient pressure, thereby reducing the complexity and capital costs of the refinement device. Mass flow rates of superheated steam in previously disclosed BNNT refinement systems are inadequate for rapid and/or complete processing of BNNT as-synthesized material into refined BNNTs suitable for BNNT intermediary materials. For example, systems using an atmospheric or near atmospheric pressure boiler/bubbler to create steam (Marincel et al. and U.S. Application Publication US20190292052A1) do not support the rapid and/or complete processing of as-synthesized BNNT material into refined BNNTs suitable for BNNT precursor feedstock materials. US20190292052A1 proposes a first temperature about 500-650° C. to remove the exposed boron particles in a process that runs from about 0.16-12 hours. This step in the processing remains important as removing the boron particles prior to the removal of BN components of a-BN, h-BN nanocages and h-BN nanosheets reduces the variety of boron oxides and borates that are generated in the subsequent processing. US20190292052A1 then discloses a second temperature, preferably about 650-800° C. to remove sufficient BN components of a-BN, h-BN nanocages and h-BN nanosheets, at process times of 12-24 hours. This results in BN component levels that are too high for using the resulting BNNT material as an intermediary feedstock for nanomaterials, particularly those calling for aligned BNNTs. Also, increasing the processing time reduces the amount of BNNT present, rendering the process unsuitable for making BNNT precursor feedstock materials.

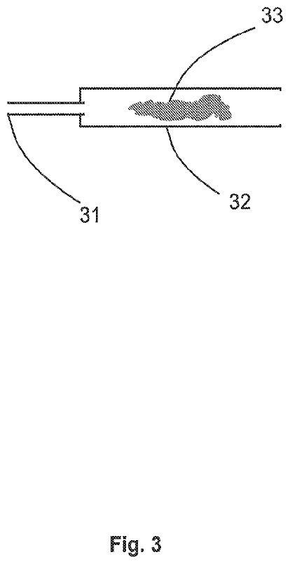

Under the present approach, a novel boiler apparatus may be used to remove boron particulates and BN components from as-synthesized BNNTs. FIG. 3 illustrates an embodiment of an apparatus 30 for removing boron particulates and BN components. As discussed Marincel et al. and U.S. Application Publication US20190292052A1, the apparatus 30 employs a feed of nitrogen and water vapor that may include air into the tube furnace 32 that contains the BNNT material 33. Prototype embodiments of apparatus 30 reduced processing times from around 24 hours to around 20 to 120 minutes depending on the operating temperature of the tube furnace, and also important, the refined material meets the requirements described herein for material to be used as BNNT intermediary materials. Following exposure, BNNT material 33 is removed from furnace 32, and a new quantity of as-synthesized BNNT material may be introduced into furnace 32 for processing. It should be appreciated that apparatus 30 may be converted into a continuous process, without departing from the present approach.

The variables for apparatus 30 include: exposure time, temperature of the BNNT material 33 being refined in furnace 32, temperature of the high temperature water vapor-nitrogen gas mixture 31, fraction of water vapor in the gas 31, and flow rate of the water vapor-nitrogen gas mixture 31. In some embodiments, oxygen, possibly as carried by air, may be introduced into the water vapor-nitrogen gas mixture 31 but this is preferably done with care as the oxygen is more reactive than the water vapor and the BNNTs can be removed and/or damaged at the same time as the h-BN nanocages and h-BN nanosheets are removed. The temperature of the BNNT material 33 is dominated by the temperature of the tube furnace 32 and in trials with prototype apparatus is typically in the range from 850-1500° C. Typical processing conditions in prototype apparatus of the present approach include: processing the as-synthesized BNNT material at a temperature between 500-650° C. to remove boron particulates and boron oxides. In some embodiments, BNNT material is subsequently processed at 700-1500° C. via radiant heat from its surroundings to remove non-BNNT, BN components such as h-BN nanocages and h-BN nanosheets. In some embodiments, 0-21 wt. % oxygen gas is mixed with the nitrogen gas to expedite removal non-BNNT BN components such as h-BN nanocages and h-BN nanosheets but this can have a detrimental effect on the BNNTs. As those with an ordinary level of skill in the art will appreciate, the times, temperatures and flow rates comprise a nonlinear system, and a change in one parameter will affect the values required for the other parameters. Additionally, changes in the as-synthesized BNNT material synthesis parameters may necessitate an adjustment of refining parameters in Step 2. For example, operating synthesis at 30-50 psi nitrogen pressure produces additional boron particulates, and operating above 80 psi produces more h-BN nanosheets.

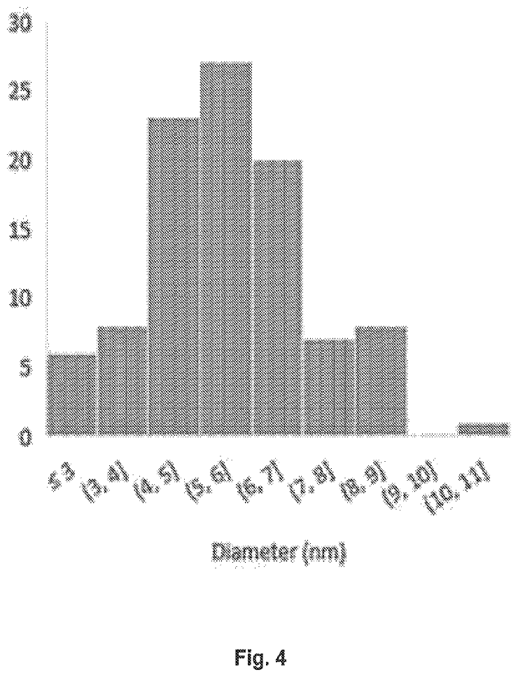

FIG. 2 shows a sample of a BNNT material following removal of boron particulates. The distribution of wall diameters and number of walls for this material is shown in FIG. 4. As discussed above, there are typically 1- to 10-walls with the peak in the distribution at 2-3-walls and rapidly decreasing with larger number of walls. In this embodiment, the yield of HQPP BNNT feedstock material in the process is consistently greater than 15 wt. %, and often significantly higher. It should be appreciated that yields exceeding 20 wt. % are important for manufacturability. In some embodiments, and largely dependent upon the as-synthesized BNNT material, the yield for HQPP BNNT feedstock material may range from 5 wt. % to 40 wt. %. For instance, the yield for an as-synthesized BNNT material that includes a significant boron particulate fraction will be less than an as-synthesized BNNT material produced with a low boron particulate fraction. Another consideration is whether the materials around the nodes where several BNNTs have joined together has been sufficiently weakened or etched away, allowing for the BNNTs to be separated in solution. The separation of BNNTs, in turn, allows for subsequently processing into a nanomaterial having aligned BNNT components.

In Step 3 shown in FIG. 1, bonds between BNNTs and any h-BN nanocages and h-BN nanosheets are broken. In this process, the refined BNNT material is processed via a wet thermal process similar to what has been described above for Step 2, but at a much higher temperature. The precise temperature and time will depend on the particular material being processed, and the apparatus used for processing. In a prototype apparatus, Step 3 occurs in the range of 750-925° C., and for a time of about 5-180 minutes. Under these conditions, the covalent bonds between BNNTs, a-BN, h-BN nanocages, and h-BN nanosheets are mostly broken, and there is minimal etching on the surfaces or along the lengths of the BNNTs. Also, the a-BN is preferentially removed. In an alternative embodiment, Step 3 can be achieved by processing the refined BNNT material in an inert environment such as helium, at temperatures ranging from 1900-2300° C., for about 5-30 minutes and sometimes longer for higher initial fractions of h-BN nanocages and h-BN nanosheets in the BNNT material. In this alternative embodiment, a-BN is generally not removed. Following Step 3, the resultant BNNT material can then be separated into constituent components.

In Step 4, the BNNT material from Step 3 may then be brought into a solution by mixing with a solvent. A large variety of solvents can be used, including most alcohols, dimethylformamide, dimethylacetamide, acetone, tetrahydrofuran, and similar solvents. Selecting a simple solvent that is easily removed in a subsequent step, such as isopropyl alcohol (IPA), is preferred. Additionally, the selection of solvent frequently depends on the subsequent processing of the material when the BNNTs are being composited in a matrix material. Techniques such as stirring, shear mixing, micro fluidization, and mild sonication, may be utilized to dissolve the BNNT material. The term “mild sonication,” as used herein, refers to sonication at an intensity and duration that breaks up agglomerations but does not damage, break up, or shorten the BNNT tubes. As should be appreciated by those of ordinary skill in the art, the amount of sonication required to achieve mild sonication will depend on the particular embodiment, including the BNNT material, the solvent, and the specifics of the instrument and concentration of the solution being utilized. Demonstrative embodiments were performed in with BNNT concentrations ranging from about 0.1-5 mg/mL in IPA, but it should be appreciated that the concentration may exceed this range in some embodiments, up to the point where the viscosity remains suitable for subsequent processing. It should be appreciated that the concentration ranges will vary for a particular solvent, but that the person having an ordinary level of skill in the art can determine a suitable concentration for a given solvent through routine experimentation. Utilization of more intense levels of sonication or extended periods of sonication may break up the BNNTs into shorter lengths, which may be a desirable outcome for some applications. As those having ordinary level of skill in the art are aware, working out the times and intensities of the sonication is an iterative process where the output of the sonication is utilized to feedback to the overall process.

Some embodiments include Step 5, to further separate nanotubes in the solution. In demonstrative embodiments, Step 5 involves microfluidic or centrifugal separation, but other methods of separating constituents in solution known in the art may be used without departing from the present approach. It should be as appreciated that not all BNNT materials following Step 4 will require further separation, and therefore not all embodiments of the present approach necessarily include Step 5. Some embodiments following Step 1 synthesis will produce as-synthesized BNNT materials with relatively large agglomerations that the stirring and mild sonication do not easily breakup without damaging the BNNTs. In these cases, Step 5 may be included to separate such agglomerations. Alternatively, Step 5 may be performed after Steps 6 or 7, should agglomerations remain.

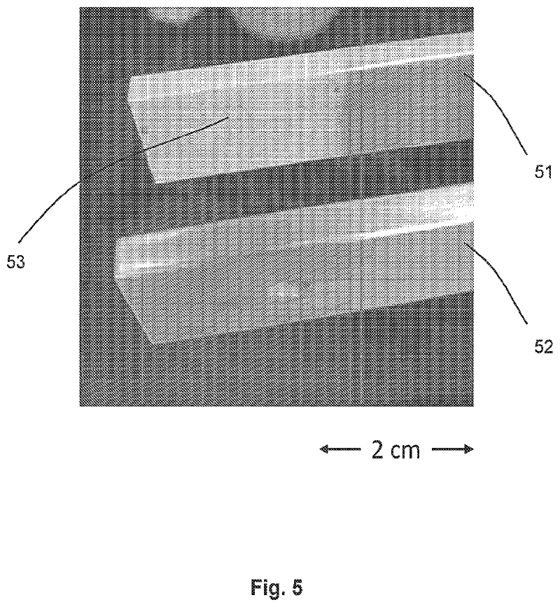

Step 6 involves electrophoresis separation. For separating the BNNTs from non-BNNT species, such as h-BN nanocages and h-BN nanosheets, electrophoresis is an effective technique. FIG. 5 illustrates electrophoresis electrodes 51 and 52, and non-BNNT species 53 collected on the anode 51. In Step 6, electrodes 51 and 52 are placed in the BNNT solution and an electric field is generated. The electric field is typically in the range of 5-25 V/cm, though fields beyond this range may be utilized in some embodiments to adjust the rate of collection.

In a demonstrative embodiment, BNNT SP10-partially purified material (BNNT, LLC Newport News, Va.) was stirred for 12-18 hours in IPA, and then sonicated for about 2 hours (mild sonication) to create a solution of 1 mg/mL of the BNNT SP10-partially purified material in IPA. Material that is partially purified has been processed for only 25-75% of the time in the higher purification range of 750-925° C. compared with the full purification discussed above such that 25-75% of the h-BN nanocages and h-BN nanosheets are still in the material. An electric field of 5-25 V/cm was applied, and the non-BNNT particles in the solution 53 deposited at a rate of 4-6 g/hr/m² on the anode electrode 51 as shown in FIG. 5. In trial processes, up to 90 wt. % of the non-BNNT particles are collected, and less than 10 wt. % of the BNNTs are collected, on the anode. The weight percentages are based on SEM analysis and mass measurements of the material collected on the anode, and the material remaining in the solution once removed from the solution. It should be appreciated that the ratio and quantity of species collected will depend on variations in electric fields, the surface areas of the electrodes, and solution concentrations. It should be appreciated that Step 6 can be repeated multiple times, to further purify the BNNTs in solution.

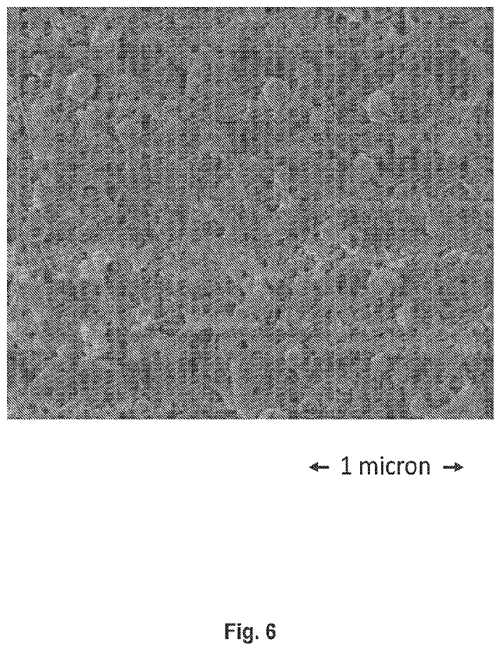

Further steps described herein are optional and may be used or omitted without departing from the present approach. In optional Step 7, the non-BNNT species (predominantly h-BN nanocages and h-BN nanosheets) may be collected for subsequent processing. For example, non-BNNT species may be scraped from the anode 51 and collected and retained for applications specifically utilizing these species. FIG. 6 shows an SEM of a sample material collected from an anode. As indicated above in Step 1, the character and ratio of the h-BN nanocages and h-BN nanosheets can be tailored by adjusting the synthesis conditions. Additionally, the material can be processed through Steps 4-6, and the parameters of the concentrations in the solutions, electric fields and processing times adjusted to separate the h-BN nanocages and h-BN nanosheets. As those of ordinary skill in the art will appreciate, the specific parameters for a given embodiment will need to be tailored for the as-synthesized BNNT material being processed.

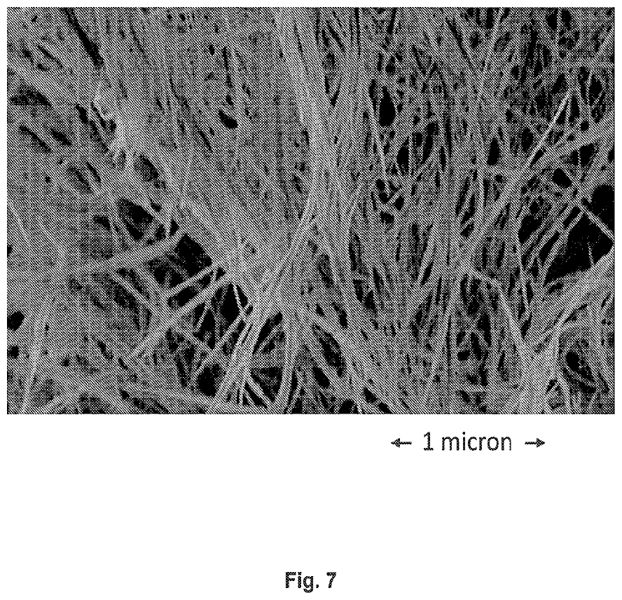

For some nanomaterial applications, the purified BNNT solution, e.g., BNNT-IPA (or other solvent), is the intermediary required. An SEM of the BNNT in a typical IPA solution of this precursor feedstock is shown in FIG. 7. As can be seen, the nanotubes are several microns in length, and have few visible nodes or other species present.

Optional Step 8 involves processing the BNNT material into the desired BNNT intermediary. Depending on the desired BNNT intermediary, four alternative processes (Steps 8a-8d) are described below. It should be appreciated that the process selected will depend on the desired BNNT intermediary.

First, Step 8a involves modifying the concentration of the BNNT material. For Step 8a, the concentration can be adjusted by, for example, by evaporation or adding additional solvent. It should be appreciated that the person having an ordinary level of skill in the art can determine the necessary amount of evaporation or additional solvent to achieve the desired concentration. The purified BNNTs in solution may be used as an intermediary material for a wide range of nanomaterials. For example, this BNNT material in solution is especially suitable for making BNNT fibers in coagulation baths, thin BNNT films such as pellicles, and combined with polymers used in electrospinning.

Second, Step 8b involves forming a BNNT mat, such as a buckypaper, from the BNNT solution. For Step 8b, the material can be filtered to create a BNNT buckypaper. These BNNT intermediary materials have a wide range of applications. For example, BNNT mats can be used as filters including high temperature filters, beam profile monitors for charged particle beams, and infused with ceramics, ceramic precursor polymers, polymers, and metals for composites. It should be appreciated that the diameter and thickness of the BNNT buckypaper can be controlled through the BNNT solution concentration, and diameter of the filter.

Third, Step 8c involves forming a BNNT powder. For Step 8c, a BNNT powder can be made from the solution by freeze drying through processes such as lyophilization or slow evaporation of the solvent that may be followed by milling. BNNT powders are useful for making uniform dispersions in materials such as silicone oils, epoxy resins, and other thermal paste materials, among other applications. In some embodiments, a co-solvent may be used to get the BNNT into a preferred solvent for the lyophilization process as those of ordinary skill in the art of freeze drying are aware.

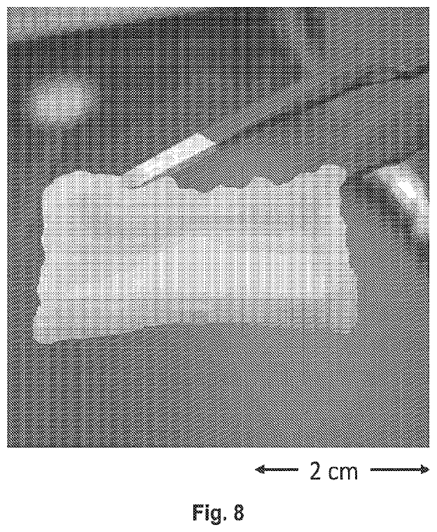

Fourth, Step 8d involves forming a BNNT gel. For Step 8d, a clean anode is placed in the solution and an electric field in the range of 5-300 V/cm or higher is applied. At field strengths ranging from 30-300 V/cm, the BNNTs collect as a gel, and using prototype processes, with a density of about 10-200 mg/mL of BNNTs in under 15 minutes without active sonication. If mild sonication is introduced into the electrophoresis bath in Step 8d, then an electric field of 5-25 V/cm may be sufficient to produce the BNNT gel intermediary material. FIG. 8 shows a BNNT gel precursor feed stock that has been pealed from the anode. It should appreciate that the electric field strength for a particular embodiment can be determined through routine experimentation and that electric fields, times and concentrations beyond the range discussed above may be utilized.

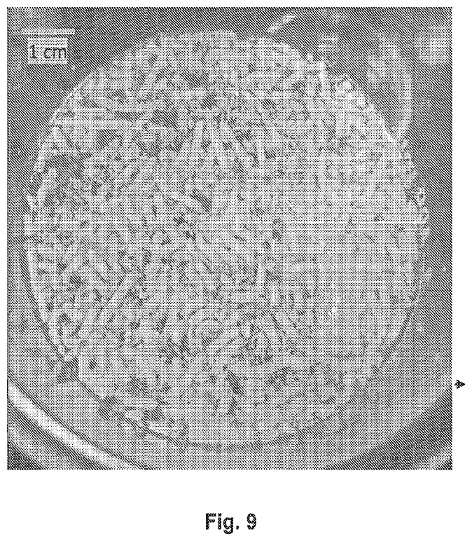

In some embodiments further processing may be desired to form a particular BNNT intermediary. For example, a BNNT gel produced in Step 8d, described above, may be further processed. For optional Step 9, the BNNT gel can be air dried or freeze dried. Air drying can be used as a route to making powders. The BNNT gel can be made into fluff, aerogels, and films, and spun into fibers utilizing standard gel spinning technologies. An example of chopped BNNT gel spun fibers are shown in FIG. 9. Typically, the BNNT gel material is extruded through an orifice or collection of orifices with holes in the range of 0.01-1 mm diameter into a solvent or solvent system in which the BNNT fiber is stable and then collected. In the example shown in FIG. 9, the BNNT gel in IPA was extruded though a 0.5 mm orifice into water and the BNNT fibers subsequently collected. These gel-spun BNNT fibers are precursor feedstock materials for subsequent applications. In some embodiments, a solution with a solute of interest, such as a polymer or a molecule for coating and/or encapsulation by the BNNTs, can be introduced into the gel. When the solvent or solvents are removed, e.g., via evaporation or freeze drying, the polymer or molecules of interest remain dispersed within the BNNT. Gels can also be an efficient form for changing the solvent, because the volume of solvent being removed is relatively low, and the BNNTs from the gel can go into the larger volume of the new solvent.

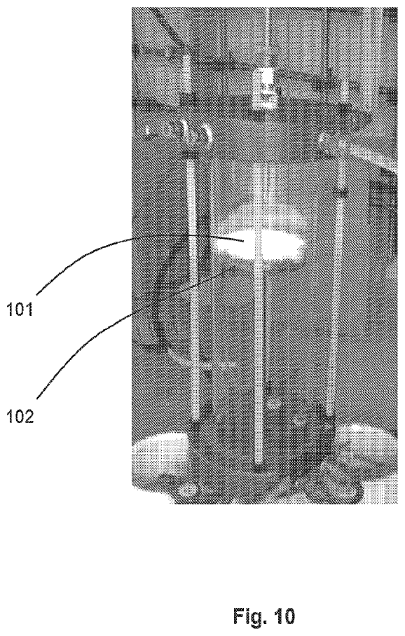

Step 10 is another optional or alternative process, in which a BNNT material following Step 8 is processed into BNNT*. Photocatalytic processes remove water contamination by per/polyfluoroalkyl substances (PFAS) via a combination of UVC light (typically near 254 nm) and BN material with high surface defect content. The term “BNNT*” refers to a BNNT intermediary material having desired surface defects, that is also hydrophilic and has surface area in excess of 300 m²/g (one quarter to half this value if the material is primarily from h-BN nanocages and h-BN nanosheets). The surface defects can be introduced by plasma treatment, ball milling where the material is broken into much smaller pieces and may include harder materials such as diamond in the milling, and acid treatment with an acid such as nitric acid. A preferred process for forming BNNT* starts with any of the forms of BNNT material discussed above, and processing the material with a plasma treatment. The plasma process is preferred because it minimally affects the structural properties of the material including the tube length while creating the desired defects. FIG. 10 illustrates a prototype plasma chamber. In this demonstrative example, argon gas at low pressure (e.g., 1-10 torr) in the presence of a DC electric field in the range from 250/1000 V/cm will create a plasma 101 on a BNNT mat 102 located on the anode. Other gases, such as helium, neon, and nitrogen, can also be utilized, but argon is preferred because of cost and lower operating electric fields. As those of ordinary skill in the art are aware, the length of the time of the treatment is determined by running tests of a given setup and material being processed, but it is typically in the range of 1-30 minutes for BNNT related materials. Additionally, the length of treatment depends on the final density of defects desired and typically some experimentation is required to tune to the character of the material being treated. In addition to BNNT mats, it should be appreciated that plasma treatment may also be used on BNNT tubes, h-BN nanocages, and h-BN nanosheets that are collected on the electrophoresis anodes. The resultant BNNT material, referred to as BNNT*, is both hydrophilic and has the density of defects required to provide photocatalytic sites for the removal of PFAS in the presence of the UVC light. BNNT* can be removed from the electrophoresis anodes and processed into formfactors appropriate for specific embodiments.

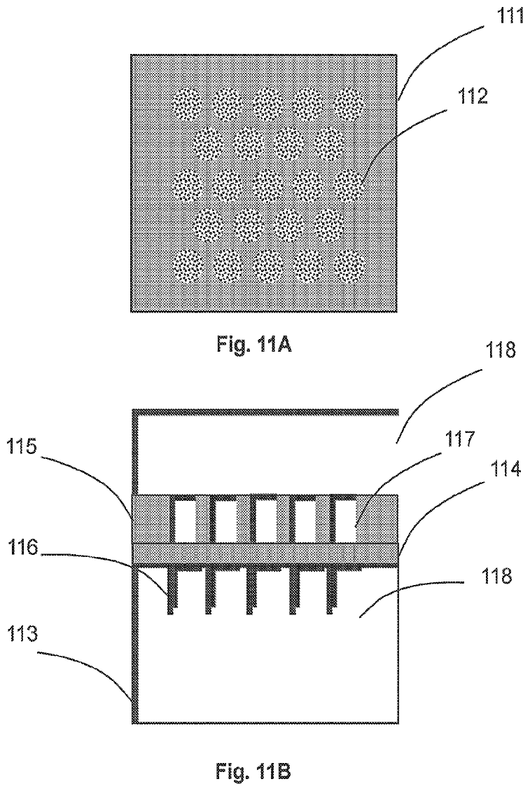

Step 11 is another optional step, and may be used to form patterned BNNT sheets. Patterns of BNNT, h-BN nanocages, and h-BN nanosheets can be collected in layers on the anode via electrophoresis process. An illustration of a pattern is shown in FIGS. 11A (top view) and 11B (side view) where the pattern is an array of cylinders 112 in a sheet of polymer film 111. It should be appreciated that embodiments with any pattern, such as curves, lines, rectangles, etc., may be used. In the electrophoresis process of Step 11, patterned growth occurs between the cathode (not shown) and above the anode 113. The anode 113 is covered by a uniform polymer film 114 and a polymer film with the desired pattern 115. The thickness of the uniform polymer film 114 is typically 0.5-5 microns, though it may be beyond this range. The thickness of the patterned polymer film 115 matches the thickness of the BNNT material 117 to be collected. In this embodiment, the BNNT material 117 is collected as cylinders, having a depth that ranges from 0.5 microns to millimeters, depending on the application of interest. An insulating material that matches the BNNT pattern is used at the anode. The anode 113 has a pattern of a secondary anode 116 set within insulators 118 that matches the pattern of the patterned polymer film 115 within the anode 113. The voltage of the secondary anode 116 operates 0.1 to 5 volts higher than that of the overall anode 113 discussed above though depending on the embodiment the secondary anode voltage can be beyond this range. The result of this arrangement is that the BNNT material being collected is preferentially initially collected in the openings 117 in the patterned polymer film 115. When the holes in the pattern 117 are filled, the BNNT material then continues to collect above 118 the patterned film 115 to whatever thickness is desired for the application.

The polymer films 114 and 115 with the collected patterned BNNT material 117 and 118 are then removed from the anode. The associated BNNT material can be stabilized and densified by placement in a coagulation bath. For example, if IPA has been used for the solvent during the electrophoresis, a different solvent such as acetone can be used for the bath. Additionally, if the polymer films are heat shrinkable, as part of the drying process the assembly can be heat shrunk to further densify the collected material if desired. Following these steps, the assembly can be placed in an oxygen rich environment, such as air, at a temperature from 350-450° C., where all of the hydrocarbons present will be oxidized and removed as gases leaving only the BNNT material in the preferred pattern for the embodiment. Patterned BNNT sheets have usefulness in various electrical components. Micro-electromechanical Systems (MEMS), such as MEMS sensors, require patterning of their elements. Patterned BNNT materials can be used at temperatures over 800° C. in air which allow them to be combined with other electrically conductive and semi-conductive components. Laser fusion targets incorporating BNNT materials may prefer targets with the BNNT structures at the 0.2-2 micron scale.

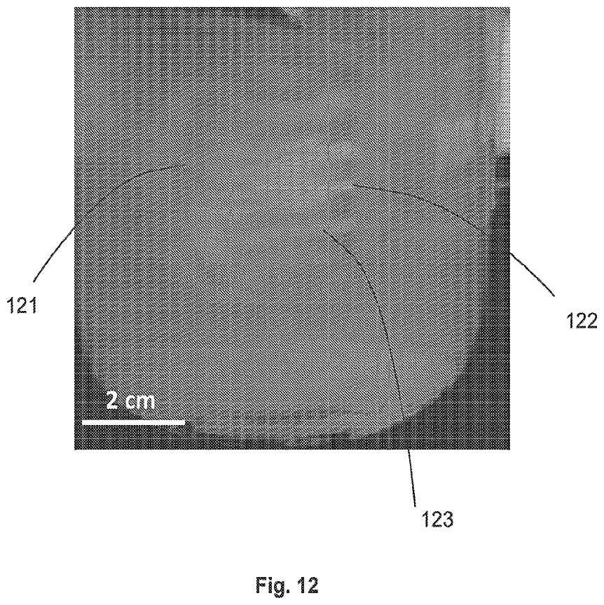

Step 12 is another optional process, in which the BNNT material is formed into aligned strands. BNNT aligned material can also be made via electrophoresis in Step 12. FIG. 12 shows BNNT material collected as strands 123 between the anode 121 and cathode 122. In this embodiment the process was run long enough that the strands reached all the way from the anode 121 to the cathode 122. The location of the strands 123 on the anode 121 and cathode 122 in this embodiment was determined by local variations in the electric field on the electrodes in a result similar to the field variations induced by the anode variations 116 discussed above. Consequently, the BNNT material for the example embodiment discussed above collected in the pattern 112 and 117 will also have alignment in the direction of the field between the electrophoresis anode 113 and cathode (not shown).

BNNT intermediary materials

BNNT puffball with covalent bonds between BNNT and non-BNNT
components broken
Non-BNNT material of h-BN nanocages and h-BN nanosheets collected
from electrophoresis anode
BNNT nanotubes in the solvent solution after removal of non-BNNT
material via electrophoresis
BNNT gel collected on the electrophoresis anode from the BNNT
nanotubes in the solvent solution
BNNT fibers spun from the BNNT gel
BNNT* materials from plasma treatments
BNNT patterned sheets collected via electrophoresis
BNNT strands collected via electrophoresis

It should be appreciated that the present approach is not limited to the specific embodiments disclosed. For example, further prototyping is underway with respect to alternate BNNT fiber spinning conditions and variations on the feedstock material. It should be appreciated that numerous such embodiments are contemplated under the present approach.

The term “about,” as used herein when referring to a measurable value, such as, for example, an amount or concentration and the like, is meant to encompass variations of ±20%, 10%, ±5%, ±1%, ±0.5%, or even ±0.1% of the specified amount. A range provided herein for a measurable value may include any other range and/or individual value within the stated range.

The terminology used herein is for the purpose of describing particular embodiments only and is not intended to be limiting of the approach. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The present approach may be embodied in other specific forms without departing from the spirit or essential characteristics thereof. The disclosed embodiments are therefore to be considered in all respects as illustrative and not restrictive, the scope of the present approach being indicated by the claims of the application rather than by the foregoing description, and all changes which come within the meaning and range of equivalency of the claims are therefore intended to be embraced therein. One of ordinary skill in the art should appreciate that numerous possibilities are available, and that the scope of the present approach is not limited by the embodiments described herein.

What is claimed is:

1. A method for producing a boron nitride nanotube (BNNT) intermediary material from an as-synthesized BNNT material, the method comprising:
removing boron particulates from the as-synthesized BNNT material;
breaking covalent bonds between BNNTs and h-BN nanocages and h-BN nanosheets in the as-synthesized BNNT material;
dissolving the BNNTs, h-BN nanocages, and h-BN nanosheets in a solvent; and
separating BNNTs from h-BN nanocages and h-BN nanosheets to produce a BNNT intermediary material.

2. The method of claim 1, further comprising separating agglomerations in the BNNTs.

3. The method of claim 2, wherein separating BNNTs from h-BN nanocages and h-BN nanosheets is performed through electrophoresis.

4. The method of claim 3, further comprising collecting h-BN nanocages and h-BN nanosheets from an anode.

5. The method of claim 1, further comprising forming a BNNT mat from the BNNT intermediary material.

6. The method of claim 1, further comprising forming a BNNT powder from the BNNT intermediary material.

7. The method of claim 1, further comprising forming a BNNT gel from the BNNT intermediary material.

8. The method of claim 7, further comprising drying the BNNT gel.

9. The method of claim 7, further comprising spinning the BNNT gel into a BNNT fiber.

10. The method of claim 1, further comprising plasma treating the BNNT intermediary material to introduce surface defects on the BNNTs in the BNNT intermediary material.

11. The method of claim 1, further comprising forming a patterned BNNT sheet from the BNNT intermediary material.

12. The method of claim 1, further comprising forming BNNT strands from the BNNT intermediary material.

13. The method of claim 1, wherein the boron particulates are removed by wet thermal processing in a nitrogen gas environment.

14. The method of claim 13, wherein the wet thermal processing comprises processing the as-synthesized BNNT material at a temperature between 500-650° C. in a water-vapor and nitrogen environment.

15. The method of claim 13, wherein breaking covalent bonds comprises processing at a temperature between 750-925° C. for about 5-180 minutes.

16. The method of claim 13, wherein breaking covalent bonds comprises processing in an inert gas at temperature between 1900-2300° C. for about 5-30 minutes.

17. The method of claim 7, wherein the BNNT gel is formed through forming an electric field in a solution containing the BNNT intermediary material.

18. The method of claim 7, further comprising extruding the BNNT gel through an orifice to form BNNT gel fibers.

19. A method for producing a boron nitride nanotube (BNNT) intermediary material from an as-synthesized BNNT material, the method comprising:
processing the as-synthesized BNNT material at a temperature between 500-650° C. in a water-vapor and nitrogen gas environment to remove boron particulates from the as-synthesized BNNT material and form a first processed BNNT material;
processing the first processed BNNT material at a temperature between 750-925° C. to break covalent bonds between BNNTs and h-BN nanocages and h-BN nanosheets and form a second processed BNNT material having BNNTs, h-BN nanocages, and h-BN nanosheets;
separating, by electrophoresis, BNNTs from h-BN nanocages and h-BN nanosheets; and
collecting the separated BNNTs as a BNNT intermediary material.

20. A method for producing a boron nitride nanotube (BNNT) intermediary material from an as-synthesized BNNT material, the method comprising:
removing boron particulates from the as-synthesized BNNT material and form a first processed BNNT material having BNNTs, h-BN nanocages, and h-BN nanosheets;
breaking covalent bonds between the BNNTs, h-BN nanocages, and h-BN nanosheets in the first processed BNNT material;
separating and collecting the BNNTs as a BNNT intermediary material.
